(19) United States
(12) Patent Application Publication
(10) Pub. No.: US 2005/0167567 A1
(43) Pub. Date: Aug. 4, 2005

(54) Device and method for pixel generation, and apparatus and method for image projection

(76) Inventor: Jose Alberto Fernandez, Barcelona (ES)

Correspondence Address: HARNESS, DICKEY & PIERCE, P.L.C., P.O. BOX 828, BLOOMFIELD HILLS, MI, 48303, US

(21) Appl. No.: 11/040,875

(22) Filed: Jan. 21, 2005

(30) Foreign Application Priority Data
Jan. 23, 2004 (EP) 04075146.3

(51) Int. Cl. G01J 1/20

(52) U.S. Cl. 250/201.1

(57) ABSTRACT

A device is provided for generating a pixel of an image, including a rotatable disk element arranged to be selectively rotatable between: a maximum luminance position, in which it blocks a minimum portion of a light path; a minimum luminance position, in which it blocks a maximum portion of the light path; and at least one intermediate luminance position, in which it blocks an intermediate portion of said light path; whereby the position of said rotatable disk element determines, at least in part, the luminance and/or the color of the pixel.

### RELATED APPLICATIONS

This application claims priority to European Patent Application No. 04075146.3 filed Jan. 23, 2004 which is hereby expressly incorporated by reference herein in its entirety.

### FIELD OF THE INVENTION

The invention relates to light projection using electronically controlled pixel generating devices.

### STATE OF THE ART

One well-known method for image projection is based on the use of the so-called Digital Micromirror Device (DMD) chip, based on a technique disclosed in, for example, EP-B-0332953.

The DMD chip is an optical semiconductor, comprising a rectangular array of a large number (for example, more than one million) of hinged microscopic mirrors, each one of which corresponds to one pixel of the image and each one of which can be individually pivoted (by application of a corresponding control signal) between an “on” position (in which the mirror projects incoming light onto a screen or similar device) and an “off” position (in which the mirror does not project incoming light onto the screen). Images can thus be projected on the screen by projecting light onto the mirror surface of the DMD chip and applying appropriate control signals (based on a digital video or graphic signal) to the chip, thus co-ordinating the position (“on”/“off”) of the respective mirrors and creating light and dark pixels on the screen or other projection surface. Grey-scales can be obtained by rapidly switching the mirror between its “on” and “off” positions, thousands of times per second. Depending on the ratio between the time when the mirror is in the “on” position and the time it is in the “off” position (and due to the “integration” of the received signals that takes place in the human visual system), lighter and darker “grey” pixels are obtained (that is, the pixels are perceived by the human observer as being more or less grey).

Different methods are known for projecting colored images using the DMD technology and spectrum recombination.

According to one method, the white light that is projected onto the mirror surface of the DMD chip is first passed through a rotating color wheel, comprising red, green and blue filter sectors or zones. Thus, the color of the light that is reflected by the mirrors changes cyclically between red, green and blue, depending on the position of the color wheel at each instant. Thus, by co-ordinating the “on”/“off” switching of the mirrors with the position of the color wheel, colored images (or, rather, images being perceived by the human observer as being colored) can be projected. This technique is disclosed in, for example, EP-B-0662773 and is used in the so-called 1-chip DLP™ (DLP™: Digital Light Processing) systems (a DLP™ system includes the DMD and related control electronics).

Another known method for obtaining colored images is based on the use of 3 DMD chips, one for each color. The incoming white light is split into a red, a green and a blue beam, each of the beams being directed onto the mirror surface of a corresponding DMD chip (that is, one chip receives the red light, another the green light and the third one the blue light), the mirrors of which are switched between their on and off states by the control signals. The light reflected by the mirrors in the “on” states of the three chips is then combined to form a colored image on the screen. Thus, each mirror of the three. DMD chips corresponds to one “pixel” of the image, and the “color” of the pixel depends on the combination of the “on”/“off” ratio of the respective mirror of each chip. This approach is used in the so-called 3-chip DLP™ projection systems.

EP-A-0798586 discloses a system for image projection including a light beam generator, an array of micro-lenses for generating a plurality of partial beams, an array of colored micro-filters or image micro-cells having size and cross-section adapted to the size and cross-section of the micro-lenses, and an activating device arranged to apply relative movement between the two arrays. Thereby, a luminous pattern can be projected, selected between various possible patterns. This system seems to be designed for projecting a limited number of predefined images.

U.S. Pat. No. 5,055,832 discloses a disk element used for image projection, and including an aperture for letting through light from an optic fibre. Basically, according to the position of the disk, the “pixel” seems to be “on” or “off”.

U.S. Pat. No. 2001/0024310 discloses a system for image projection in which light is transmitted along a path including a color filter layer. A micro-electromechanical device comprising a rotary shifter is used for, selectively, blocking the light and letting the light through. Basically, according to the position of the rotary shifter, the “pixel” is “on” or “off”.

U.S. Pat. No. 6,201,633 discloses a micro-electromechanical based system for image projection, involving the use of a shutter comprising petal-like torsionally-hinged shutter segments that can be moved from a horizontal (closed) to a vertical (open) position by using electrostatic attraction forces. Each “pixel” can be considered to correspond to several of the petal-like shutter segments, whereby the pixel can be selectively set into an “on” state, an “off” state and some “intermediate” states, according to the number of shutter segments that are in the closed and in the open position, respectively. However, each pixel involves a plurality of movable elements, and seems to present a rather complex structure.

It is an object of the invention to provide an alternative system and method in which, by setting a simple mechanical shutter element into one of a plurality of predetermined positions, different levels of luminance and/or different colors can be obtained.

### SUMMARY

A first aspect of the invention relates to a device for projecting or generating a pixel of an image. The device comprises:
an inlet end arranged for receiving light from a light source;
an outlet end arranged for receiving light from the inlet end and for letting out light received from the inlet end; and
at least one displaceable element arranged so that the position of the displaceable element determines the proportion between the amount of light let out at the outlet end and the amount of light received at the inlet end, by selectively blocking a light path between the inlet end and the outlet end.

In accordance with the invention, the at least one displaceable element comprises a rotatable disk element arranged to be selectively rotatable between:
a maximum luminance position, in which it blocks a minimum portion (for example, 0%) of the light path and thus prevents a minimum portion (for example, 0%) of light received at the inlet end from being let out at the outlet end;
a minimum luminance position, in which it blocks a maximum portion (for example, 100%) of the light path and thus prevents a maximum portion (for example, 100%) of light received at the inlet end from being let out at the outlet end; and
at least one intermediate luminance position, in which it blocks an intermediate portion (for example, 25% and/or 50% and/or 75%) of the light path, thus preventing a corresponding intermediate portion of light received at the inlet end from being let out at the outlet end, the intermediate portion being larger than the minimum portion and smaller than the maximum portion.

In this way, the position of the rotatable disk element determines, at least in part, the luminance (thus determining the grey scales of the pixel) and/or the color (especially when using several disk elements associated with color filters) of the pixel. The invention thus provides for pixel projection in which the blocking element can provide not only for “on” and “off” levels, but also for “intermediate” levels, in accordance with the angular position of the disk element. Thus, the device makes it possible to, for example, provide for “grey scales” of the pixel without relying on the rapid shifting between an “on” state and an “off” state of the pixel, which is necessary when the grey scales are to be obtained relying on the integration that takes place in the visual system of a human observer.

Many small motors involving rotatable disks are known. Thus, the device of the invention makes it possible to use such, often simple, motors, for regulating the portion of the light from the inlet end that reaches the outlet end. Thus, the luminance and/or color of the pixel can be determined by applying control signals to the motors of each pixel device. These motors can have very simple and non-expensive structures and, nevertheless, have a very high reliability and thus providing for rapid and exact control (for example, digital control) of luminance and/or color of the filters. A large number of suitable motors are known by any person skilled in the art of, for example, micro-electromechanical systems (MEMS).

Preferably, the rotatable disk element is a micro-electromechanical disk element, for example, a micro-electromechanical disk element forming part of a micro-electromechanical motor arranged for rotating the disk element in accordance with control signals applied to the motor. For example, the micro-electromechanical motor can be arranged for rotating the disk element step by step, thereby providing for simple and reliable control of the angular position of the disk element. The motor can be an electrostatic micro-electromechanical motor. The disk element can be provided with projections or “teeth” arranged to interact with corresponding actuator elements of a stator part of the micro-electromechanical motor, to which control signals can be supplied.

The disk element can be a substantially circularly shaped disk element.

The disk element can be a substantially opaque disk element including at least one through hole (or a transparent or translucent area corresponding to a portion of its surface) for letting through light (preferably, in a direction substantially perpendicular to the surface of the disk element). The through hole can extend over (occupy) between 35% and 65% of the surface of the disk element (for example, over approximately 50% of the surface, for example, corresponding to a 180° sector of the circular disk element).

The disk element (or several disk elements) can be arranged on a substrate, the substrate including a through hole (or, if there are more than one disk element arranged on the same substrate, one through hole for each disk element), such as a semi-cylindrical tunnel, for letting through light. The through hole in the substrate can be arranged so that, in at least one angular position of the disk element, the through hole of the disk element is positioned, at least partly, in correspondence with (aligned with) the through hole of the substrate, whereby light can pass through both of the through holes following the light path between the inlet end and the outlet end. That is, the through hole in the substrate and the through hole in the disk element can be aligned along the light path, whereby light from the inlet end can pass through the through holes and arrive at the outlet end. When the disk element is rotated away from the aligned position, the amount of light passing through both through holes is reduced, in accordance with the angular position of the disk element.

The disk element can be arranged to rotate in a plane substantially perpendicular to the light path between the inlet end and the outlet end.

The disk element or elements can be made of, for example, polysilicon, metal or any other material suitable for micro-electromechanical motors.

The device can comprise a plurality of the displaceable elements, each comprising one of the rotatable disk elements. The device can further comprise N color filters, N>2, each one of the color filters being arranged to let through light of a pre-determined color, the color being different for each one of the color filters. At least one of the rotatable disk elements can be arranged in correspondence with each one of the color filters, whereby the positions of the rotatable disk elements determine, at least in part, the amount of light arriving at the outlet end from the color filters, thereby determining, at least in part, the contribution of the light let through the corresponding color filter, to the total luminance and color of the pixel, thus providing for projection of color images using spectrum recombination.

The N color filters can comprise one red, one blue and one green filter, for letting through red, blue and green light.

Each color filter can be arranged between the inlet end and the outlet end.

A further aspect of the invention relates to an apparatus for image projection, comprising:
a plurality of devices as described above, arranged so that each device corresponds to a pixel of an image to be projected;
at least one light source for providing light to the inlet ends of the devices;
electronic control circuitry for providing control signals to each one of the devices, for selectively setting the rotatable disk elements of the devices into one of the maximum, minimum and intermediate luminance positions, for obtaining a desired luminance and/or color of the corresponding pixel. The light source can be a white light source.

A further aspect of the invention relates to a method for generating a pixel of an image in an image projection system. The method comprises the steps of:
supplying light to an inlet end of a light path having the inlet end and an outlet end arranged for receiving light from the inlet end and for letting out light received from the inlet end; and
selectively blocking the light path, so as to determine the proportion between the amount of light let out at the outlet end and the amount of light received at the inlet end.

According to the invention, the step of selectively blocking the light path comprises selectively rotating a rotatable disk element between:
a maximum luminance position, in which it blocks a minimum portion of the light path and thus prevents a minimum portion of the light supplied to the inlet end from being let out at the outlet end;
a minimum luminance position, in which it blocks a maximum portion of the light path and thus prevents a maximum portion of the light supplied to the inlet end from being let out at the outlet end; and
at least one intermediate luminance position, in which it blocks an intermediate portion of the light path, thus preventing a corresponding intermediate portion of the light supplied to the inlet end from being let out at the outlet end, the intermediate portion being larger than the minimum portion and smaller than the maximum portion.

In this manner, the position of the rotatable disk element determines, at least in part, the luminance and/or the color of the pixel.

By the method, the angular position of the rotatable disk element is used to select the luminance of the pixel (and/or, in multi-color-filter systems, the color of the pixel).

Preferably, the method further comprises the step of using, for selectively blocking the light path, a micro-electromechanical motor having a rotor part constituting the rotatable disk element, whereby the rotation of the disk element is performed by applying control signals to a stator part of the motor. This makes it possible to produce cheap and reliable devices for controlling the luminance (and/or color) of the pixel; each disk element can adopt a plurality of angular positions, corresponding, for example, to one “on” or “maximum luminance” position, one “off” or “minimum luminance” position and one or several “intermediate luminance position”, under control of the control signals applied to the stator part.

The disk element can be rotated in a plane substantially perpendicular to the direction of the light path from the inlet end to the outlet end; preferably, the disk element is provided with at least one through hole (or with a transparent or translucent portion) for letting through light.

The method can further comprise the steps of:
letting light pass through N color filters, N>2, each color filter being arranged in a corresponding light path; and
combining the light from the light paths so as to obtain a composite color of light at the output end;
wherein at least three rotatable disk elements are used, each disk element being arranged for selectively blocking light corresponding to one of the color filters, so as to determine, at least in part, the contribution of the light let through the corresponding color filter, to the total luminance of the pixel.

A further aspect of the invention relates to a method for displaying or projecting an image, by projecting (for example, on a screen) a plurality of pixels of the image using, for each pixel, a method as outlined above; the rotatable disk elements are selectively rotated by applying, using electronic control circuitry, displacement control signals generated based on an input signal, such as an input graphic or video signal, corresponding to the image or images to be projected or displayed.

### BRIEF DESCRIPTION OF THE DRAWINGS

FIG. 1 schematically illustrates a preferred embodiment of the invention, suitable for projection of a pixel of a color image.

FIGS. 2A-2C schematically illustrates the selective blocking of the light path by rotating the disk element, in accordance with a preferred embodiment of the invention.

FIG. 3 is a top view of a disk element in accordance with a preferred embodiment of the invention.

FIG. 4 is a side view of the disk element in accordance with the preferred embodiment of the invention.

FIG. 5 is a perspective view of the disk element in accordance with the preferred embodiment of the invention.

FIG. 6 is a top view of the disk element in accordance with the preferred embodiment of the invention, mounted on a substrate.

FIG. 7 is a top view of the substrate as per FIG. 6, with the disk element removed.

FIG. 8 is a transversal cross sectional side view of the disk element mounted on the substrate, in a maximum luminance position.

FIG. 9 is the side view as per FIG. 8, but after rotation by 180° of the disk element.

FIG. 10 is a bottom view of the disk element, also illustrating positions of the actuators used for displacing the disk element.

### DESCRIPTION OF PREFERRED EMBODIMENTS OF THE INVENTION

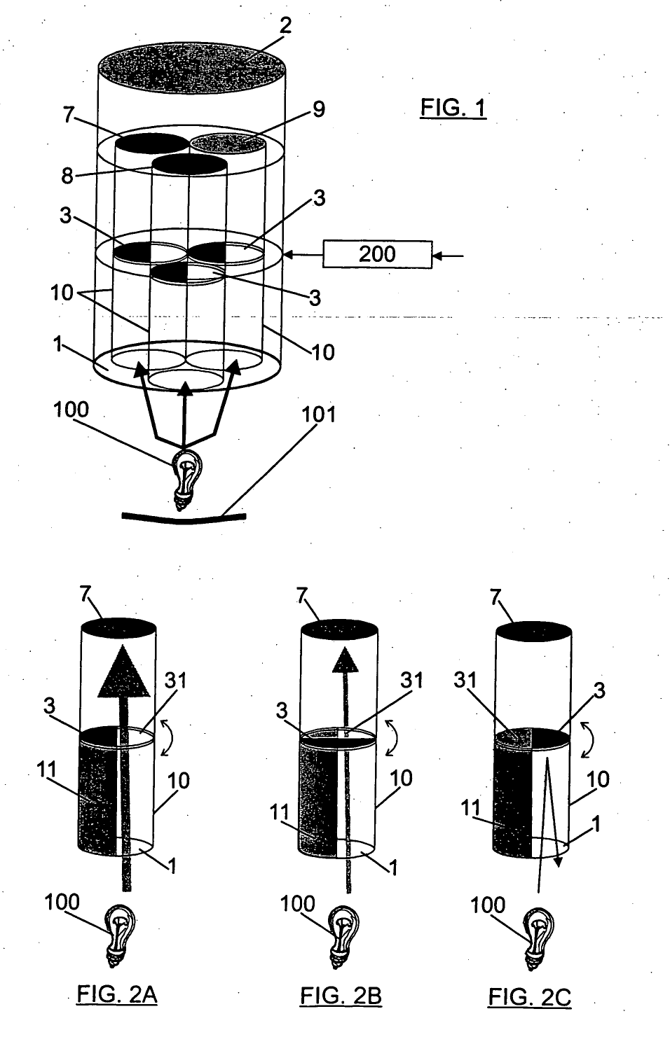

FIG. 1 schematically illustrates a preferred embodiment of the invention, wherein the pixel device is arranged for receiving, at an inlet end 1, light coming from a light source 100 for white light, positioned above a mirror 101. The light is let in at the inlet end, from which it passes through perforations, tunnels or similar light path 10 defining means, each associated with a rotatable disk element 3, towards an outlet end 2. The rotation of the disk element is controlled by electronic control circuitry 200 (schematically illustrated), arranged to control the rotation of the disk elements in accordance with control signals derived from signals related to the image to be displayed (for example, graphic or video signals).

The device further comprises, at a position along each one of the light paths, a color filter 7, 8, 9; one of the color filters is a red color filter 7, another is a blue color filter 8, and the third one is a green color filter 9. Thus, at the outlet end 2, red, green and blue light is received from the respective light paths; at the outlet end, the light is combined (for example, using a suitable lens arrangement, not shown) to provide for a composite color of the pixel, by spectrum recombination. The color of the pixel depends on the contribution of the light passing through the red, green and blue filters, respectively, to the total light output at the outlet end 2.

Thus, in accordance with the invention, the proportion of the light let in at the inlet end 1 that arrives at the outlet end can be regulated by selectively “blocking” the respective light paths. Thus, for example, if the light path corresponding to the green color filter 9 is completely blocked whereas the light paths corresponding to the red and the blue filters are completely open, a violet composite color is obtained at the outlet end. Substantially the same color is obtained, but with a lower luminance, if the light path corresponding to the green color filter is kept completely blocked, whereas the light paths corresponding to the red and blue filters are each blocked to 50%, etc.

FIGS. 2A-2C schematically illustrate how the light paths can be blocked by rotating the disk element, according to a preferred embodiment of the invention and in relation to the light path 10 corresponding to the red color filter 7. Basically, the light path 10 is defined by a tunnel having, below the disk element 3, a fixed opaque portion 11 that blocks the light, leaving a semi-cylindrical passage open for letting through light; thus, light from the light source 100 can only flow through the semi-cylindrical part of the light path not blocked by the fixed opaque portion 11. Now, each disk element has a through hole 31, in this case, corresponding to about 50% of the surface of the disk element, namely, to a 180° sector of the disk element.

In FIG. 2A, the through hole 31 is aligned with the non-blocked part of the light path 10; this position corresponds to the maximum luminance position, that is, to the position providing for maximum luminance at the outlet end.

In FIG. 2B, the disk element 3 has been rotated 90° in the plane perpendicular to the direction of light along the light path. Now, only 50% of the through hole 31 correspond to the non-blocked portion of the light path; this position corresponds to an intermediate luminance position (providing for a reduced luminance at the outlet end).

In FIG. 2C, the disk element 3 has been rotated 180° from the position of FIG. 2A and the through hole 31 is now positioned in alignment with the blocked portion of the light path; this position corresponds to the minimum luminance position; in this case, no light is let through to the outlet end.

That is, if the arrangement of FIGS. 2A-2C corresponds to the red color filter 7 part of the arrangement of FIG. 1, in the position of FIG. 2A, there is a maximum contribution of red color light to the total color and luminance of the pixel;
in the position of FIG. 2B, there is an intermediate contribution of red color light to the total color and luminance of the pixel;
in the position of FIG. 2C, there is a minimum contribution of red color light to the total color and luminance of the pixel (in this case, no contribution of all, as the light path 10 is completely blocked by the opaque portion 11 of the light path in combination with the opaque portion of the disk, that is, the portion of the disk not corresponding to the through hole 31).

A rotatable disk element 3 in accordance with a preferred embodiment of the invention is shown in FIG. 3. The disk element comprises a substantially flat, circular disk element 3 having an opaque portion 32 and a through hole 31 for letting through light when aligned with a non-blocked portion of a light path. The disk element is arranged to be selectively rotated around a shaft 33, under the control of control signals applied to actuators or stator parts (not shown in FIG. 3) of an electrostatic micro-electromechanical motor; the disk element 3 constitutes the rotor part of the motor.

FIG. 4 shows a side view of the disk element, illustrating the rotor “teeth” or projections 34 with which the actuator or stator part of the motor interacts, for causing the disk to rotate, in accordance with the conventional techniques well known in the art.

FIG. 5 is a perspective view of the disk element 3, showing the opaque (blocking) portion 32, the through hole 31, the teeth or projections 34 and the shaft 33 around which the disk element can pivot or rotate.

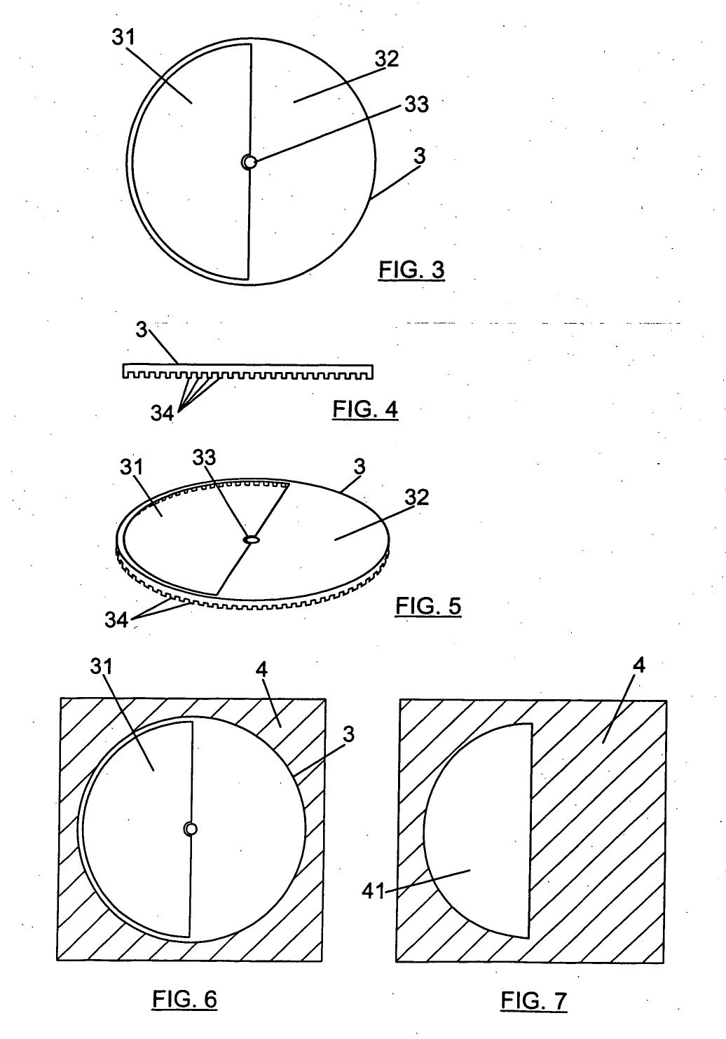

FIG. 6 is a top view of the disk element 3 (with its through hole 31) mounted on a substrate 4. The disk element 3 can be manufactured of polysilicon (a commonly used material for manufacture of micro-electromechanical systems or MEMS) and the substrate 4 can be made of, for example, silicon. FIG. 7 shows the substrate without the disk, and it can be observed how the substrate is provided with a cavity or through hole 41 having a size and shape approximately corresponding to the size and shape of the through hole 31 of the disk elements (although it is by no means necessary that the sizes and shapes be the same or similar). Now, when the disk element 3 is mounted on the substrate 4, depending on the angular position of the disk element, its through hole 31 can be more or less aligned with the cavity or through hole 41 of the substrate; the degree of alignment determines the degree of blocking of the light path.

The substrate can constitute or make up a part of the means for defining a light path such as the light path 10 of FIGS. 1 and 2A-2C. In that case, the substrate can also constitute the “opaque” portion 11 illustrated in FIGS. 2A-2C.

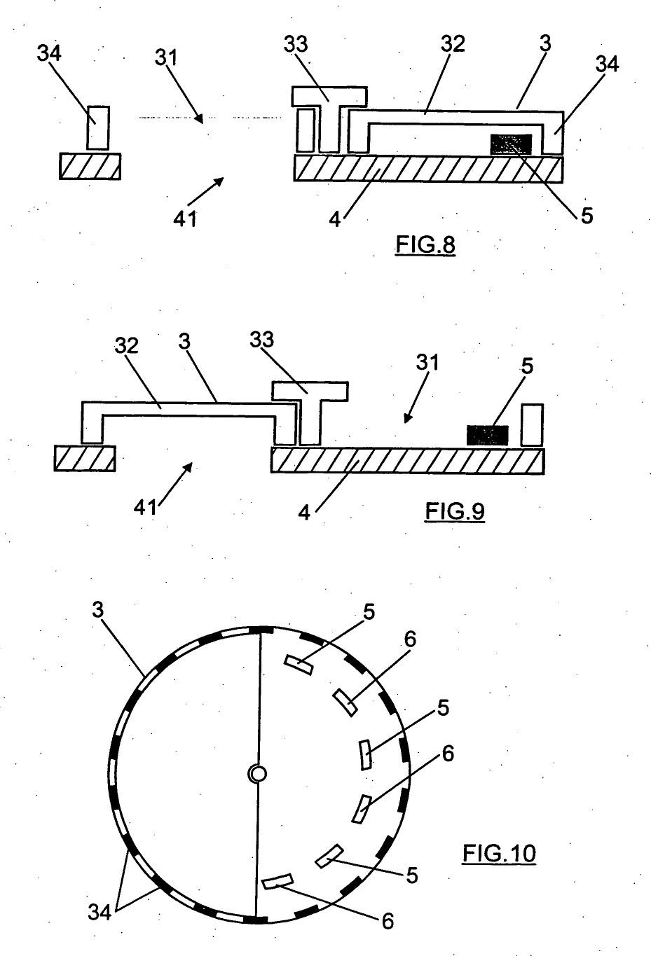

FIGS. 8 and 9 show two side views (in transversal cross section) of the disk element 3 mounted on the substrate 4.

In FIG. 8, the disk element is in the “maximum luminance” position: the through hole 31 of the disk element is aligned with the cavity or through hole 41 of the substrate 4, and light can flow along the light path from the inlet end to the outlet end, without being blocked by the disk element 3.

FIG. 9 shows the same arrangement but after rotating the disk element 180° around the shaft 33. Here, the through hole 31 of the disk element is no longer aligned with the cavity or through hole 41 of the substrate 4; instead, the opaque portion 32 of the disk element 3 covers the through hole of the substrate 4 and, thus, blocks the light path defined by the through hole 41 in the substrate 4. This position corresponds to a minimum luminance position.

In FIGS. 8 and 9, an actuator element 5 is also schematically shown; by applying control signals to the actuator element, electrostatic forces will act between the actuator element 5 and the adjacent “tooth” or projection 34 of the disk element; by applying suitable control signals to the actuator elements, the disk element can be forced to rotate around the shaft 33, in a well-known manner.

FIG. 10 is a bottom view of the disk element 3, schematically showing its teeth or projections 34 and two groups 5 and 6 of actuator or stator elements, which are embodied on the substrate (not shown in FIG. 10) and to which the control signals are applied in a well-known manner, for producing the desired rotation of the disk element to the desired position, thereby determining the proportion of the light from the inlet end that will be allowed to reach the outlet end.

Throughout the description and claims of the specification, the word “comprise” and variations of the word, such as “comprising”, are not intended to exclude other additives, components, integers or steps.

1. A device for generating a pixel of an image, the device comprising:
an inlet end arranged for receiving light from a light source;
an outlet end arranged for receiving light from said inlet end and for letting out light received from said inlet end; and
at least one displaceable element arranged so that a position of the displaceable element determines a proportion between an amount of light let out at the outlet end and an amount of light received at the inlet end, by selectively blocking a light path between said inlet end and said outlet end;
wherein said at least one displaceable element comprises a rotatable disk element arranged to be selectively rotatable between:
a maximum luminance position blocking a minimum portion of the light path and preventing a minimum portion of light received at the inlet end from being let out at said outlet end;
a minimum luminance position blocking a maximum portion of the light path and preventing a maximum portion of light received at the inlet end from being let out at said outlet end; and
at least one intermediate luminance position blocking an intermediate portion of said light path and preventing a corresponding intermediate portion of light received at said inlet end from being let out at said outlet end, said intermediate portion of light being larger than said minimum portion of light and smaller than said maximum portion of light; and
wherein the position of said rotatable disk element determines, at least in part, at least one of the luminance and the color of the pixel.

2. A device according to claim 1, wherein the rotatable disk element comprises a micro-electromechanical disk element.

3. A device according to claim 2, wherein said rotatable disk element forms part of a micro-electromechanical motor arranged for rotating the disk element in accordance with control signals applied to said motor.

4. A device according to claim 3, wherein said micro-electromechanical motor is arranged for rotating the disk element step by step.

5. A device according to claim 3, wherein the motor comprises an electrostatic micro-electromechanical motor.

6. A device according to claim 3, wherein the disk element is provided with projections arranged to interact with corresponding actuator elements of a stator part of the micro-electromechanical motor.

7. A device according to claim 1, wherein the disk element comprises a substantially circularly shaped disk element.

8. A device according to claim 1, wherein the disk element comprises a substantially opaque disk element including at least one through hole for letting through light.

9. A device-according to claim 8, wherein said through hole occupies between 35% and 65% of a surface of the disk element.

10. A device according to claim 1, wherein the at least one disk element is arranged over a substrate, said substrate including a through hole for letting through light.

11. A device according to claim 10 wherein the disk element comprises a substantially opaque disk element including at least one through hole for letting through light, and wherein said through hole in the substrate is arranged so that, in at least one angular position of the disk element, the through hole of the disk element is positioned at least partly aligned with the through hole of the substrate, wherein light can pass through both of said through holes following the light path between the inlet end and the outlet end.

12. A device according to claim 1, wherein the disk element is arranged to rotate in a plane substantially perpendicular to a direction of the light path between said inlet end and said outlet end.

13. A device according to claim 1, wherein the at least one disk element comprises polysilicon.

14. A device according to claim 1, wherein the at least one disk element comprises metal.

15. A device according to claim 1, wherein the device comprises a plurality of said displaceable elements, each displaceable element comprising one of said rotatable disk elements.

16. A device according to claim 1, wherein said device further comprises N color filters, N≧2, each one of said color filters being arranged to let through light of a pre-determined color, said color being different for each one of said color filters; and
wherein at least one of said rotatable disk elements is arranged in correspondence with each one of said color filters, wherein positions of said rotatable disk elements determine, at least in part, an amount of light arriving at said outlet end from said color filters, to determine, at least in part, a contribution of the light let through the corresponding color filter to a total luminance and color of the pixel.

17. A device according to claim 16, wherein said N color filters comprise one red color filter, one blue color filter and one green color filter, for letting through red, blue and green light, respectively.

18. A device according to claim 16, wherein each color filter is arranged between said inlet end and said outlet end.

19. An apparatus for image projection, comprising:
a plurality of devices in accordance with claim 1, arranged so that each device corresponds to a pixel of an image to be projected;
at least one light source for providing light to the inlet ends of said devices;
electronic control circuitry for providing control signals to each one of said devices, for selectively setting the rotatable disk elements of the devices into one of said maximum, minimum and intermediate luminance positions, for obtaining at least one of a desired luminance and color of the corresponding pixel.

20. An apparatus according to claim 19, wherein the light source comprises a white light source.

21. A method for generating a pixel of an image in an image projection system, comprising the steps of:
supplying light to an inlet end of a light path having said inlet end and an outlet end arranged for receiving light from said inlet end and for letting out light received from said inlet end;
selectively blocking the light path so as to determine a proportion between an amount of light let out at the outlet end and an amount of light received at the inlet end;
wherein the step of selectively blocking the light path comprises selectively rotating a rotatable disk element between:
a maximum luminance position blocking a minimum portion of the light path and preventing a minimum portion of the light supplied to said inlet end from being let out at said outlet end;
a minimum luminance position blocking a maximum portion of the light path and preventing a maximum portion of the light supplied to the inlet end from being let out at said outlet end; and
at least one intermediate luminance position blocking an intermediate portion of said light path and preventing a corresponding intermediate portion of the light supplied to said inlet end from being let out at said outlet end, said intermediate portion of light being larger than said minimum portion of light and smaller than said maximum portion of light;
wherein the position of said rotatable disk element determines, at least in part, at least one of the luminance and the color of the pixel.

22. A method according to claim 21, further comprising the step of using, for selectively blocking the light path, a micro-electromechanical motor having a rotor part constituting said rotatable disk element, wherein rotation of said disk element is performed by applying control signals to a stator part of said motor.

23. A method according to claim 21, wherein the disk element is rotated in a plane substantially perpendicular to a direction of the light path from said inlet end to said outlet end, said disk element being provided with at least one through hole for letting through light.

24. A method according to claim 21, further comprising the steps of:
letting light pass through N color filters, N>2, each color filter being arranged in a corresponding light path; and
combining the light from said light paths so as to obtain a composite color of light at the output end;
wherein at least three rotatable disk elements are used, each disk element being arranged for selectively blocking light corresponding to one of said color filters, so as to determine, at least in part, the contribution of the light let through the corresponding color filter, to a total luminance and color of the pixel.

25. A method for projecting an image, by projecting a plurality of pixels of said image using, for each pixel, a method according to claim 21, the rotatable disk elements being selectively rotated by applying, using electronic control circuitry, displacement control signals generated based on an input signal corresponding to an image to be projected.
